(19) United States
(12) Patent Application Publication
(10) Pub. No.: US 2008/0155239 A1
(43) Pub. Date: Jun. 26, 2008

(54) Automata based storage and execution of application logic in smart card like devices

(75) Inventors: Atish Datta Chowdhury, Bangalore (IN); Namit Chaturvedi, Dashehra Maidan (IN); Meenakshi Balasubramanian, Bangalore (IN); Arul Ganesh, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/545,440

(22) Filed: Oct. 10, 2006

(51) Int. Cl. G06F 9/44

(52) U.S. Cl. 712/245; 235/487

(57) ABSTRACT

A small intelligent device has a memory that stores a finite state automaton, an input/output interface that receives an input and provides an output, and a processor. The processor is arranged to receive the input and to traverse the finite state automaton stored in the memory in order to supply the output to the input/output interface. The automaton may be an embodiment of context sensitive and context independent rules that are enforced by the automaton execution logic.

### TECHNICAL FIELD OF THE INVENTION

The present invention relates to an arrangement for storing and executing automata on user carried small intelligent devices. A user carried small intelligent device is a portable device that has memory, such as non-volatile memory, and that has a two-way communication facility. The user carried small intelligent device may also have a processing unit and a programming interface. Examples of user carried small intelligent devices include cell phones, PDAs, tablet PCs, smart cards, and Java-powered smart buttons.

### BACKGROUND OF THE INVENTION

The description below refers to the use of small intelligent devices, such as smart cards. However, it should be understood that the present invention is applicable to any user carried small intelligent device that can interface with other devices, such as readers and/or a central authority, so as to allow the user carrying the user carried small intelligent device to perform certain functions such as to gain access to a resource.

Moreover, although the present invention is discussed herein in the specific context of access control, it should be understood that the present invention is pertinent to any application such as those whose behavior can be expressed in First Order Logic or Monadic Second Order Logic. Therefore, the applications of the present invention are not to be limited to access control.

Small intelligent devices such as smart cards, which have the capability of storing information and performing some computations, are becoming increasingly popular in a variety of applications. Such devices can be exploited by these applications to provide newer sets of functionalities to the user and to improve the user experience. The typical applications in which smart cards in particular can be employed successfully are voting systems, access control systems, user loyalty programs, citizen information systems, and ticketing systems.

Although these applications use smart cards for storing relevant information, these applications do not fully utilize the capabilities provided by the smart card environment, which include but are note limited to on-board processing. It has been observed that the processing infrastructures of smart cards have been used for the management of internal memory, the data storage structure, and efficient data organization, and not for executing application functionality.

In spite of the storage and processing capability provided by small intelligent devices such as smart cards, they inherently limit processing speed and the size of the application and/or data that can be downloaded. These limitations make such devices unattractive for some classes of applications that require a large application logic and/or a fast response time.

Although the processing power and memory capacities of small intelligent devices are bound to substantially increase with time, the application domain and resource requirements will expand proportionately. In the absence of efficient storage structures and execution mechanisms, the limitations described above will be present in various applications and use scenarios.

Hence, it is desirable that a formal execution framework be devised so as to enable applications to delegate a part of their application logic to small intelligent devices such as smart cards.

### SUMMARY OF THE INVENTION

Consequently, according to one aspect of the present invention, a small intelligent device comprises a memory, an input/output interface, and a processor. The memory stores a finite state automaton. The input/output interface receives an input and provides an output. The processor is arranged to receive the input and to traverse the finite state automaton stored in the memory in order to supply the output to the input/output interface.

According to another aspect of the present invention, a method of programming a small intelligent device comprises the following: populating a memory of the small intelligent device with a data structure of a finite state automaton; and, initializing the finite state automaton to an initial state, wherein the finite state automaton is of a type that transitions from the initial state to a next state in response to an input and the data structure that stores the finite state automaton.

According to still another aspect of the present invention, a system comprises a small intelligent device and a reader device. The small intelligent device has a device memory, a device communication input/output interface including two-way communication channels, and a processor, and the device memory stores a data structure of a finite state automaton. The reader device has a memory, a two-way communication interface with the small intelligent device, and an input-output interface, and the reader memory stores an execution logic of the finite state automaton. The device communication interface and the reader communication interface interact so as to execute the finite state automaton.

### BRIEF DESCRIPTION OF THE DRAWINGS

These and other features and advantages will become more apparent from a detailed consideration of the invention when taken in conjunction with the drawings in which:

FIG. 1 shows an application using an automaton stored on a small intelligent device according to an embodiment of the present invention;

FIG. 2 shows an example of a simple automaton;

FIG. 3 shows a binary decision diagram representing the simple automaton of FIG. 2;

FIG. 4 shows a tabular representation of the Binary Decision Diagram illustrated in FIG. 3;

FIG. 5 shows a flow chart representing one example of a program that is useful in encoding a small intelligent device with an appropriate Binary Decision Diagram and an execution logic that executes the Binary Decision Diagram;

FIG. 6 shows an example of an access control system using a small intelligent device programmed with Binary Decision Diagram and execution logic as described herein;

FIG. 7 shows an example of a small intelligent device that stores the Binary Decision Diagram and/or execution logic as described herein;

FIG. 8 shows an example of execution logic that can be stored on a small intelligent device;

FIG. 9 is an example of a switching circuit representation of the automata that can be stored in the small intelligent device;

FIG. 10 shows an example of an adjacency list; and,

FIG. 11 illustrates the offline high level analyzer of FIG. 5 in more detail.

### DETAILED DESCRIPTION

The invention described herein, according to one embodiment, applies to applications whose behavior can be captured and specified by a user and stored in small intelligent devices such as smart cards or similar devices. Rules may be established to dictate the behavior of such applications. For example, in terms of access control, rules may be established to assist in making decisions in response to grant/deny requests.

Some examples of the applications, whose behavior can be captured and specified by a user and stored in small intelligent devices, are physical access control systems, logical access control systems, systems that automate assembly lines, systems useful in preserving homeland security, asset management systems, and systems that manage supply chains.

A physical access control system manages access to physical resources, such as rooms, which have physical access points, such as doors through which the room is accessed. The policies that define the access authorization of users to physical resources may be stored in a small intelligent device in the form of a binary decision diagram (which may be referred to as a BDD).

A logical access control system is similar in functionality to a physical access control system and differs primarily in that the access is to logical resources like files, directories, and other entities in computer systems. A small intelligent device stores the policies pertaining to the users of these logical resources, and these policies are used to make access control decisions when users try to access the logical resources.

A typical assembly line, such as a car assembly line, involves assembling a specific set of discrete parts into a whole structure. The parts that need to come together in a specific order and from specific lots constitute a correct assembly of the components. The rules that specify the dynamically varying order and the consignment for each component of a large system forms the set of policies that are enforced by encoding the rules/policies as automaton and corresponding Binary Decision Diagram structures stored on the small intelligent device.

For example, every part can be tagged with a small intelligent device (e.g., a microchip such as may be used in an RFID tag or some other identification module) to inform the decision points of its arrival. The microchip contains the policy storage and execution model. The various decision points in the model control and regulate the movement of these small individual parts so that they are available at the appropriate places and times for correct and faster assembly.

A system that provides homeland security needs to be sufficiently scalable and flexible to be able to manage policies corresponding to large numbers of users who need access to resources spread over large areas like townships and cities. The policies that grant or deny access to specific sets of resources are encoded in small intelligent devices that are provided to users, and are used to help identify potential threats to the resources. The Binary Decision Diagram structures encoded in the small intelligent devices define the access control policies and restrictions that are enforced when the users request access to the specific resources.

An asset management system tracks, associates, identifies, and efficiently manages critical assets in an organization. Each such asset is provided with a small intelligent device in the form of a tag that uniquely identifies the assets. Rules are provided to associate the assets to each other or to specific set(s) of users who are owners or users of the assets. The small intelligent device stores the association and usage policies for the assets and users, and is associated with each asset and the user in the asset management system.

As an example, to manage a laptop within a facility, the laptop is tagged with a small intelligent device which is capable of storing and processing information. The small intelligent device contains details pertaining to the ID of the asset to which it is attached, the users who can use the asset, the region(s) within the facility in which the asset can be moved, and the operations that the individual users can perform on the asset. These rules are enforced within the facility to monitor, track, and control the usage of the asset.

Supply chain management is the oversight of materials, information, and finances as they move in a process from supplier to manufacturer to wholesaler to retailer to consumer. Supply chain management involves coordinating and integrating these flows both within and among companies. The rules that define the movement and tracking of status of the relevant entities in the supply chain management system is accomplished by tagging the entities with small intelligent devices that are used to track the entities as they move through the system. The small intelligent devices, tagged to the entities to be managed within the supply chain, contain the rules on how the entities are used, moved, and managed within the supply chain.

In accordance with an embodiment of the present invention, the policies that map users to resources and to control access to or use of resources are encoded as automata and are stored and processed within a small intelligent device as a Binary Decision Diagram.

For example, in the situation where a user carried small intelligent device controls access to file resources on a networked or stand-alone computer, the small intelligent device can be arranged to communicate with the computer via a hardware device interface, such as a smart card reader in case of a smart card type of small intelligent device, or via an USB port in case of a plug-in small intelligent device, or via a wireless link, such as a blue-tooth or infra-red communication link, in the case of a wireless small intelligent device. The type of small intelligent device and interface that can be used will depend upon the available device/computer interface.

The small intelligent device contains the policy storage and execution model and authorizes the user to access or use the logical resource. It may subsequently control which resources (e.g. applications and folders) the user can access, depending upon past usage patterns and dynamically evaluated policies.

The present invention in one embodiment deals with efficiently storing and executing application specific policy/rules defined by the user as an automaton in a small intelligent device. The automaton is represented as a Binary Decision Diagram. The Binary Decision Diagram encoded automaton which represents the policy to be enforced and the program code that processes the automaton at runtime are downloaded into the small intelligent device.

The encoding of application logic as an automaton inside the small intelligent device provides several advantages. For example, combined policies can be efficiently stored. On average, a Binary Decision Diagram stores an automaton in a compact form. Thus, the space used in the small intelligent device for representing the automaton, which in turn is a translation of the policies encoded by the user, is very efficient.

Also, the policies can be efficiently executed at runtime. Binary Decision Diagrams are appropriate structures for the efficient evaluation of the next state transition functions in an automaton as they only encode that portion of the input symbol that is required for the next state evaluation.

Moreover, the execution model can be incorporated within the small intelligent device, which enables the hosting of execution of the application logic within the small intelligent device. In addition, the use of the automaton structure makes the internal policy/rule representation more application independent.

The applications described above are characterized by users who need access to resources. Access to these resources is frequently dependent on the context which captures the dynamics of the application. Rules may be dictated by certain policies that are dependent on the context. These rules constitute the application logic and have to be evaluated to make an allow/deny decision in response to an access request.

In terms of context sensitivity for an access control system, a policy embodied by the automaton, for example, might provide that a requesting user is allowed access only if the occupancy of a room is less than or equal to a predetermined capacity limit, such as 20 occupants. In such a case, an allow or deny decision is dictated by the system context involving the occupancy of the room.

Existing applications support centralized execution of rules to make decisions in response to an access request. Since it is well-known that centralized solutions do not scale up well with increasing user demand, de-centralized solutions to the above problems are desirable. In a de-centralized solution, the application logic should be stored in such a way that it can be executed locally to make a decision in response to an access request. This de-centralized solution scales up well with an increase in the number of users. A small intelligent device that stores and executes an automaton embodying the policies and/or rules pertinent to the application is ideal for the de-centralized solution.

While many devices can be used to suit the needs of a de-centralized architecture of such applications, small intelligent devices that provide a good abstraction for interaction between the clients and readers are especially suitable. Examples of such small intelligent devices include, inter alia, cell phones, smart cards, SIM cards, and Java-powered smart buttons which have some memory and processing power and are popularly used to uniquely identify users. They also belong to a popular range of devices that conform to ISO 7816 and other standards that are built on top of it.

A de-centralized execution of an application is defined by storing the application logic in a small intelligent device and executing the application locally when this small intelligent device is carried in proximity to and/or in contact with a device reader. To be able to do this storing efficiently, mechanisms are used to specify and execute the application logic such that the application logic is amenable to compact storage and fast execution. An embodiment of such a mechanism is described below in detail.

Exploiting formal specification systems like First Order (FO) Logic or Monadic Second Order (MSO) Logic makes it possible to capture both context sensitive and context independent policies and rules. Available with the system administrator is an intuitive English-like policy specification language, which can be abstracted with a user friendly graphical user interface, and which is used to define the policies at a very high level. These policy definitions, along with some configuration information, are input to a high level analyzer tool which parses the policy definitions and generates a logic representation of the rules. The rules are defined over a fixed set of events that constitute fundamental behavior of the application. This logic is then represented as an automaton over the set of events. The automaton is stored in a small intelligent reader readable device and is executed upon request to make an allow/deny decision.

There are various ways of representing an automaton for storage and execution. For example, a state transition table is an exhaustive list of possible next states from a given state in the automaton. The possible next states follow upon consumption of an input symbol that constitutes a part of the language that the automaton accepts. Upon reaching a state, in a run of the automaton, the next state can be determined by looking at the arriving input symbol and the mapping which maps this symbol with a next state.

Another way of representing and implementing an automaton could be a program written in any known programming language like C, Java, Lisp, etc. Such a program can capture the execution of an automaton in the form of a combination of if-then-else statements, or any other means thereof.

The Binary Decision Diagram representation of an automaton is like a switching circuit representation. In the switching circuit representation, the next state of the automaton is a function of the input and the previous state. That is, Next-State=f(Input, Previous-State). Both the Binary Decision Diagram and a circuit representation of an automaton incorporate only those pieces of the input information that are required for deciding the next state, and any additional information is not included in the final representation.

A simple example of switching circuit representation of the automata has a transition matrix given in the following table, where the top row represents the input and the other row represent states of the switching circuit.

input

| State | 00 | 01 | 10 | 11 |
|---|---|---|---|---|
| 0 | 0 | 0 | 0 | 1 |
| 1 | 1 | 1 | 1 | 2 |
| 2 | 2 | 2 | 2 | 2 |

### This transition matrix may be represented by the following truth table.

| | | |
|---|---|---|
| Current | Input | Next |
| State | Word | State |

| A | B | C | D | Y1 | Y2 |
|---|---|---|---|---|---|
| 0 | 0 | 0 | 0 | 0 | 0 |
| 0 | 0 | 0 | 1 | 0 | 0 |
| 0 | 0 | 1 | 0 | 0 | 0 |
| 0 | 0 | 1 | 1 | 0 | 1 |
| 0 | 1 | 0 | 0 | 0 | 1 |
| 0 | 1 | 0 | 1 | 0 | 1 |
| 0 | 1 | 1 | 0 | 0 | 1 |
| 0 | 1 | 1 | 1 | 1 | 0 |
| 1 | 0 | 0 | 0 | 1 | 0 |
| 1 | 0 | 0 | 1 | 1 | 0 |
| 1 | 0 | 1 | 0 | 1 | 0 |
| 1 | 0 | 1 | 1 | 1 | 0 |

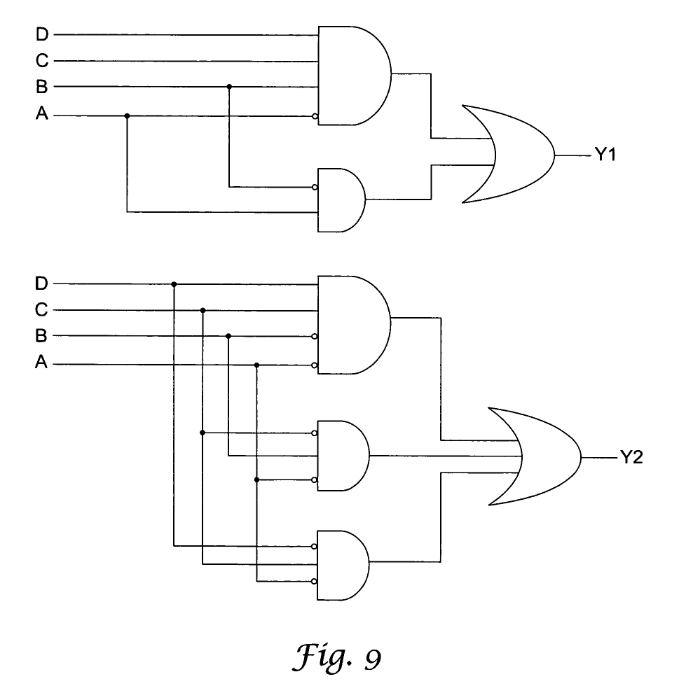

### The minimized switching circuit representation for the truth table derived from the transition matrix is shown in FIG. 9.

Other methods of implementing an automaton include adjacency matrices, adjacency lists, transition matrices, etc.

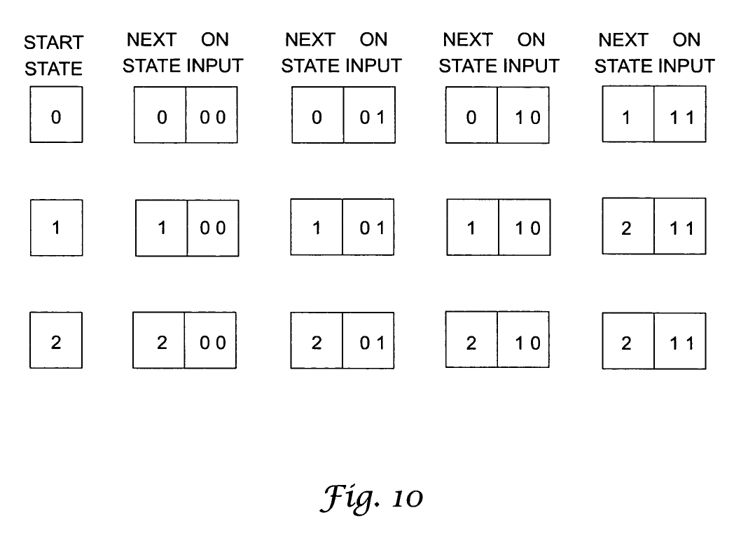

FIG. 10 shows an example of an adjacency list.

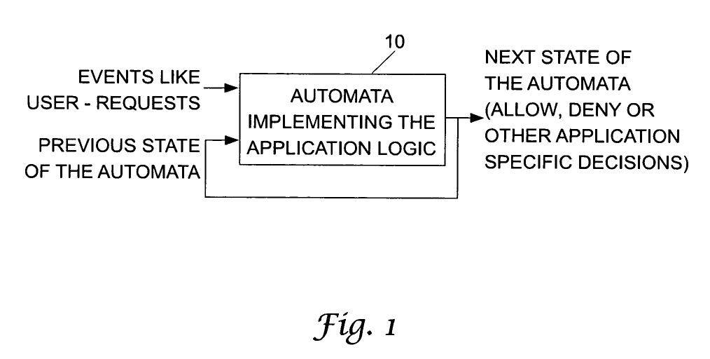

Use of an automaton to execute application logic is shown in FIG. 1 where an automaton 10 implements the application logic such that the next state of the automaton 10 is a function of the input (in this case, an event such as a user request) and the previous state of the automaton 10.

Binary Decision Diagrams have advantages over the other decision methods described above in terms of the space required for storage of the automaton representation, as well as that required in intermediate steps. On average, a tabular representation of a Binary Decision Diagram has the properties of both optimal storage and fast execution.

Given an automaton with N states, the worst case size of the corresponding Binary Decision Diagram in terms of nodes is an exponential with respect to N. In practice, however, the average Binary Decision Diagram size is found to be linear with respect to the number of states N. In general, the number of nodes in a Binary Decision Diagram is always greater than or equal to the number of nodes of the automaton. However, a Binary Decision Diagram representation has some attractive properties such as compactness and canonicity (the property that an expression or a formula can be expressed in a standard and conventional (i.e., canonical) form), and it allows efficient manipulation.

Using a Binary Decision Diagram representation, it is possible to execute a run of the automaton on a given set of inputs with the help of just one additional variable, which is used to capture the present state of the automaton. The set of inputs constitutes a set of events of the application. These events are fed to the automata and, consequently, to Binary Decision Diagrams which capture the automata. The additional variable is a variable that holds the current state of the automaton execution.

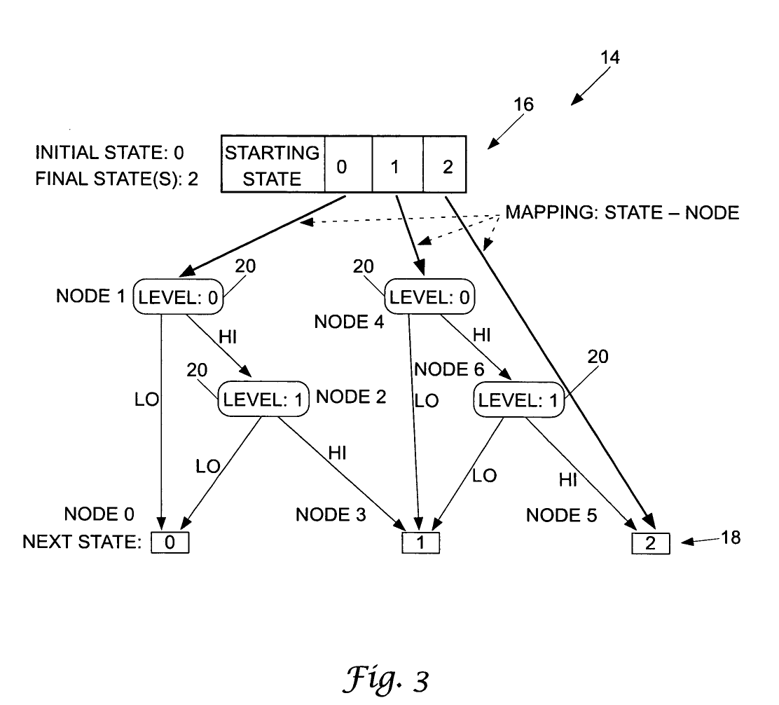

The manner of representing finite state automata as Binary Decision Diagrams is described below. Binary Decision Diagrams are used to represent the transition relation of the automaton. A supplementary data structure 16 (FIG. 3) maps the states of the automaton with the nodes in the Binary Decision Diagram. Binary Decision Diagrams augmented with this data structure are called Shared Multi-terminal Binary Decision Diagrams (SMBDDs). The nodes constitute the roots and leaves of individual trees. Given that the automaton is in state Sᵢ, a state transition upon consumption of any input I will be captured by a Binary Decision Diagram tree rooted at a node that is mapped to the state Sᵢ. The leaves of this tree contain the data structure indices of possible next states in the automaton that can be reached from the state Sᵢ after consuming various inputs. These next states in turn map to nodes in the Binary Decision Diagram that have other trees rooted at them to capture subsequent transitions. Every node has a level associated with it. The level stands for the depth in the tree at which the node appears. Nodes in the root row 16 and the leaf row 18 are not considered while discussing “level” of a node. A node may appear in more than one tree; however, the level of the node will remain the same in all the trees.

A state transition in the automaton from state Sᵢ to Sⱼ given an input I is captured in the Binary Decision Diagram by a traversal of the tree rooted at the Binary Decision Diagram node that corresponds to the state Sᵢ. Since the Binary Decision Diagram is a binary tree, a decision is taken at every node whether to follow one of two sub-trees, a low sub-tree or a high sub-tree.

Given a node at the k^{th} level in the tree, the k^{th} bit of the input (Iₖ) directs the next traversal. If the bit is high (1) then the traversal takes the high branch (the right branch as viewed in FIG. 3 discussed below), and if it's low (0) then the traversal takes the low branch (the left branch as viewed in FIG. 3 discussed below). The deepest level possible in a tree is equal to the size of the binary input. Thus, an N bit input traverses N levels of the Binary Decision Diagram. The nodes at the leaves of the tree correspond to the next states in the automaton—Sⱼ in this example. It is worth mentioning at this point that all the input strings (symbols) for a Binary Decision Diagram are necessarily binary strings, i.e., a sequence of 0's and 1's. Various parameters that constitute inputs can be represented as unique binary sequences.

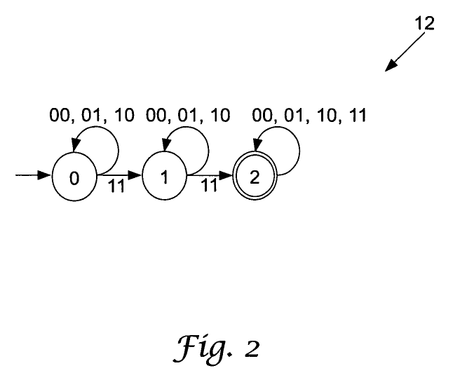

A simple automaton 12 shown in FIG. 2 is represented in the form of a Binary Decision Diagram 14 shown in FIG. 3. A top row 16 of square corner boxes shows the roots of the Binary Decision Diagram trees, and a bottom row 18 of square corner boxes shows the leaves of the Binary Decision Diagram trees. These root and leaf nodes are the nodes of the Binary Decision Diagram that correspond to some states in the automaton. The circular cornered boxes 20 represent nodes of the Binary Decision Diagram that participate in the transition function. The solid thick arrows from the roots in the top row 16 map the states in the top row 16 to a node in the tree.

At level i, the i^{th} most significant bit of the input is checked. Given whether the bit is high or low, the appropriate sub-tree is followed. Reaching a leaf node marks the end of a transition. This node represents the next state of the automaton.

As an example to see how the representation of transitions is optimized in a Binary Decision Diagram representation, notice the transitions from state 2 in FIG. 2. All inputs transition the automaton back to state 2, which is shown by the solid thick arrow in FIG. 3. In the final encoding, no transitions for state 2 need to be explicitly defined. Only, a self loop needs to be specified.

Similarly, if the automaton is in state 1, all transitions of the form 0[0|1] take the automaton back to state 1. Hence the Binary Decision Diagram tree only checks for the least significant bit to be 0 to determine whether or not the next state should be 1. If the least significant bit is 1, then the most significant bit decides whether the next state is 1 or 2.

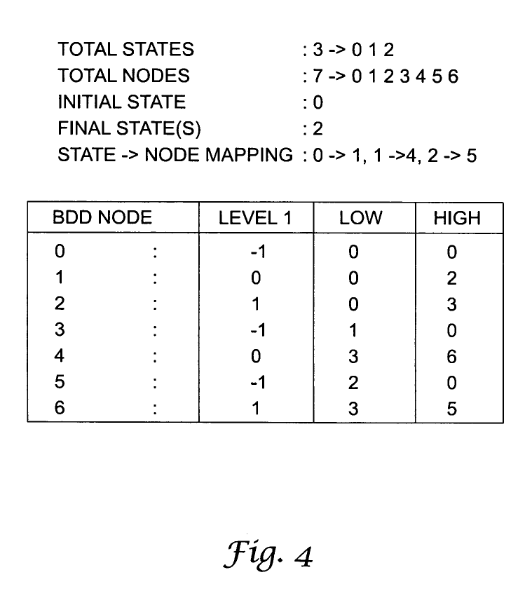

The tabular representation of the Binary Decision Diagram tree shown in FIG. 3 is given in FIG. 4. FIG. 4 illustrates the tabular representation of the method for storing the Binary Decision Diagram. The various components of FIG. 4 are defined in the table below.

| Binary Decision | |
|---|---|
| Diagram Component | Description |
| Binary Decision | Unique index assigned to each node in |
| Diagram Node | the Binary Decision Diagram tree |
| | structure. |
| Level | A value of −1 means that the |
| | corresponding node maps to a state of |
| | the automaton. A value greater than or |
| | equal to 0 means that the number given |
| | by this field is used for indexing into |
| | the input string. |
| Low | If the level value corresponding to |
| | this entry is −1, then the value of |
| | this field represents the index of the |
| | state of the automaton to which this |
| | node is mapped. Otherwise, the node is |
| | mapped to the next node in the |
| | traversal which is to be taken if the |
| | input bit indexed by the Level field is |
| | 0. |
| High | If the level value corresponding to |
| | this entry is −1, then the value of |
| | this field is zero. Otherwise, the |
| | node is mapped to the next node in the |
| | traversal which is to be taken if the |
| | input bit indexed by the Level field is |
| | 1. |

This tabular form is a concise way of representing the Binary Decision Diagram, and has all the information required for executing a run of the automaton in terms of consuming a set of input strings. A Binary Decision Diagram table containing M entries is stored as an array of records, indexed 0 to (M-1). The i^{th} record stores the i^{th} row of the table and hence holds the behavior of the i^{th} node of the Binary Decision Diagram. This node behaves in exactly the same way as that described in the above table.

Given an input string and a record, the value of the Level entry of the record indexes the bit that is to be considered. If the value in the Level column is greater than or equal to 0, and if the bit under consideration is 0 (lo), the number present in the Low column is the index of the node that falls next in the order of node traversal. If the value in the Level column is greater than or equal to 0, and if the bit under consideration is 1 (hi), the number present in the High column is the index of the node that is to be followed next.

On the other hand, if the value in the Level column for an entry is −1, then this entry represents a node that is mapped to a state of the automaton. The index of the state to which the node is mapped is present in the Low column of the entry. The High column is necessarily 0 in this case.

The end of a transition is reached when such a node is reached in the traversal. The maximum value of an element present in the Level column is equal to the size of the bit encoding. It is possible that not all bits of an input are analyzed in a traversal, i.e., in the process of consumption of that input. The maximum value of an element in the Low or High column is the total number of Binary Decision Diagram nodes minus one.

It is noted that that the table of FIG. 4 has only three levels, 0 and 1, corresponding to the two levels of the Binary Decision Diagram of FIG. 3, which also corresponds to the length of the input binary string in FIG. 2. However, more complex Binary Decision Diagrams will have more levels. Each level corresponds to a bit of the input.

The level of −1 is a special level. It denotes that the node (which has −1 as the value for level) corresponds to a state of the automaton that the binary decision diagram represents. The index of the state is stored in the Low field of the node. The State→Node map then points to the node that acts as a root of the tree beginning at this state. On arriving at this state, a next state transition that is initiated by the arrival of an input symbol will start at this root. Nodes in the root row 16 and the leaf row 18 of FIG. 3 are not considered while discussing levels. These nodes appear in the binary decision diagram table in rows that have −1 for level. Therefore, a node that represents a state also appears in the leaf row. This is to say that this node (and hence the state) may be reached as a result of some state—transition.

A data structure stores the mapping from the set of automaton states to the set of Binary Decision Diagram nodes that form the root of the Binary Decision Diagram trees. This mapping captures the transitions from the corresponding states. One variable of the data structure is required to store the index of the current state of the automaton. An array of the data structure may be required to store all the accepting states. If an input string (or a set of strings) takes the automaton from any state to one of the accepting states, then that string (or the set of strings) is accepted by the automaton.

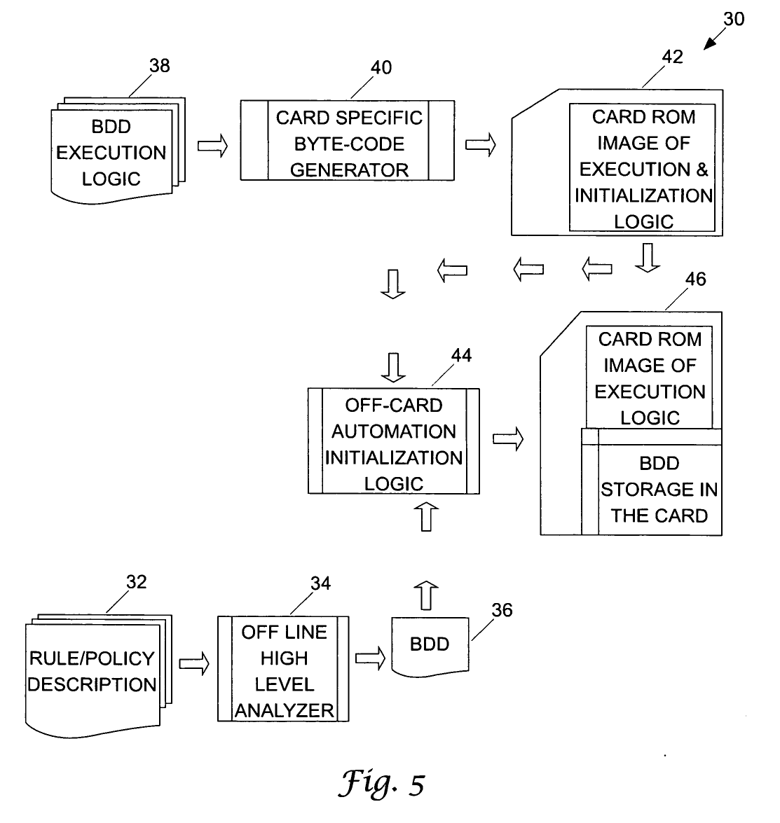

One example of a program 30 that encodes the small intelligent device with the appropriate Binary Decision Diagram and the execution logic that executes the Binary Decision Diagram is shown by way of flowchart in FIG. 5. The program 30 converts a rule/policy description to a final Binary Decision Diagram encoded automaton that is downloaded into the smart-card. Accordingly, the rules are specified at 32 by a user using a user friendly mechanism (such as formal English-like phrases or graphical symbols), and are converted at 34 into a Binary Decision Diagram 36.

Any process may be used at 34 to convert the rules/policies specified at 32 into the Binary Decision Diagram 36. For example, an offline high level analyzer having a high level policy parser may parse the policies, the parsed policies may then undergo Monadic Second Order Logic (MSO Logic) specification, and the MSO Logic specifications may be converted by an MSO policy analyzer to the Binary Decision Diagram 36.

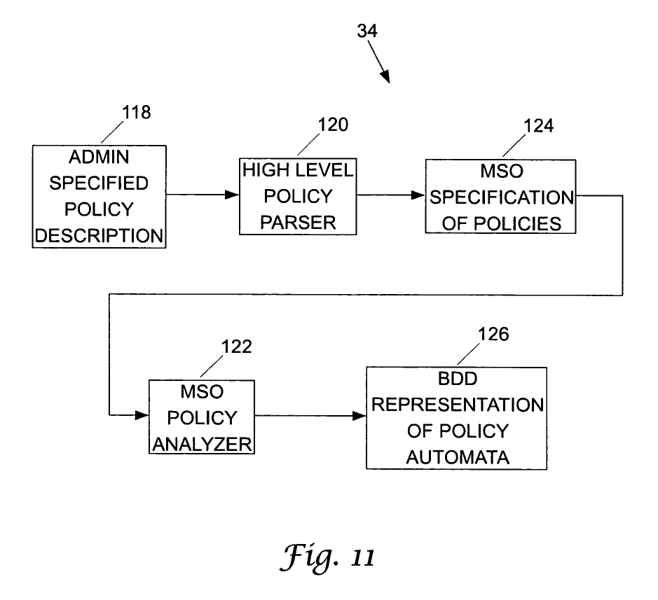

FIG. 11 illustrates the utility of the offline high level analyzer 34. The offline high level analyzer 34 comprises two important components, viz. a high level policy parser 120 and a MSO policy analyzer 122. While the high level policy parser 120 is application dependent, the MSO policy analyzer 122 may be a generic program.

An administrator defines the policies in a high level English-like specification 118, which follows a grammar. The grammar in this context refers to a language generation rule. The high level policy parser 120 parses the policy input supplied by the administrator 118 in accordance with the grammar and translates the policy input into a corresponding MSO logic policy formula at 124. The high level policy parser 120 uses knowledge of the application domain to effectively perform the translation. This translation can be carried out using well known parsing techniques available from Alfred V. Aho, Ravi Sethi, Jeffrey D. Ullman in “Compilers Principles, Techniques, Tools”, Reading, Ma., Addison-Wesley, 1986, and well known tools disclosed by S. C. Johnson in “YACC—Yet another compiler compiler”, Technical Report, Murray Hill, 1975, and by Charles Donelly and Richard Stallman in “Bison: The YACC-Compatible Parser Generator (Reference Manual)”, Free Software Foundation, Version 1.25 edition, November 1995. Thus, the formulation of an application specific grammar and the consequent construction of the high level policy parser 120 can be carried out in accordance with the existing literature as cited above.

For example, in access control, an English-like policy may be stated as follows: User may enter Room A if a context ZC holds. The representation of the policy as a MSO logic formula may look like the following: ∀ t″, ∃ t′: exists_Z_{c}(t″) & request_for_room A(t′) & t″<=t′ [symbol] ∃ t: allow_into-room A(t) & t=t′+1 & ∀ t: allow_into-room A(t) [symbol] ∃ t″, t′: exists_Z_{c}(t″) & request_for_room A(t′) & t<=t′ ∃ t: & t′=t″−1.

In English, this formula states that, at any time instant “t”, the user may be allowed into Room A if and only if there was a request made for access at the immediately preceding time instant (“t′=t−1”) and the context Z_{c} already held. The context Z_{c} may stand for the presence of a supervisor in the room or any other credential required to gain access to Room A. Here, the knowledge that the request for access has to be taken into account comes from the application domain. Different needs may also direct different MSO policy formulas for the same English-like specification.

The second component of the offline high level analyzer is the MSO policy analyzer 122. The MSO policy analyzer 122 is a generic component that, given an MSO logic formula, or a conjunction or a disjunction of a set of formulas, converts the formula(s) into the corresponding automata representation 126. Formal proofs and construction of the MSO policy analyzer 122 can be obtained from Thomas, W. in “Languages, automata, and logic,” in Handbook of Formal Languages, Vol. III, Springer, New York, 1977, pp. 389-455.

The execution logic is designated by the reference numeral 38 and is in the form of program code that is used for executing the Binary Decision Diagram representation available in the small intelligent device is converted by software 40 into a byte-code that is specific to the particular small intelligent device to receive the Binary Decision Diagram and the execution logic.

Software 40 is written specifically for a given kind of small intelligent device and may be obtained from the vendor of the small intelligent device. Its function is to compile a program written in any known language, like Java or C, into a format that can be downloaded and possibly executed on the small intelligent device. The output of the software 40 is then downloaded on the small intelligent device using a device interface.

The byte code is a software module 42 that is divided into two parts, a binary decision diagram initialization program and the execution logic 38. The initialization program collaborates with an off-device initialization program 44 and perform the following steps: 1) populate the binary decision diagram data structure on the small intelligent device 46; and, 2) set the current state variable to an appropriate value, e.g., the initial state may be set to 0.

Once the binary decision diagram data structure is initialized, the execution logic is ready to consume any input string and perform the state transition function.

An off-device binary decision diagram structure initialization software 44, for example, may consist of a program that reads a tabular representation of the binary decision diagram 36, such as shown in FIG. 4, and transfers its contents to the small intelligent device 46 via an appropriate communication or an I/O interface.

In terms of the software module 42 and the off-device initialization program 44, a personal computer, attached with a facility that can communicate with the small intelligent device 46, can host the off-device initialization program 44. The off-device initialization program 44 issues instructions to the software module 42 via an input of the small intelligent device 46 to receive binary decision diagram related information and to store this information in its memory. This operation results in the storage of the binary decision diagram data structure in the small intelligent device 46. A similar operation may result in the storage of the execution logic in the small intelligent device 46.

Thus, the program 30 reads through a file in the format specified in FIG. 4, extracts the necessary information, and communicates with the small intelligent device instructing it to write the corresponding values. If there is any change in the policies, the steps for re-initializing the data structures remain the same. There might be some additional overhead incurred if some information from the old state of the automaton is to be extracted and processed.

Immediately after initialization, the current state of the automaton as stored on the small intelligent device is set to the initial state. This is a node where execution begins.

FIG. 4 is an example of the data structure that is stored on the small intelligent device 46.

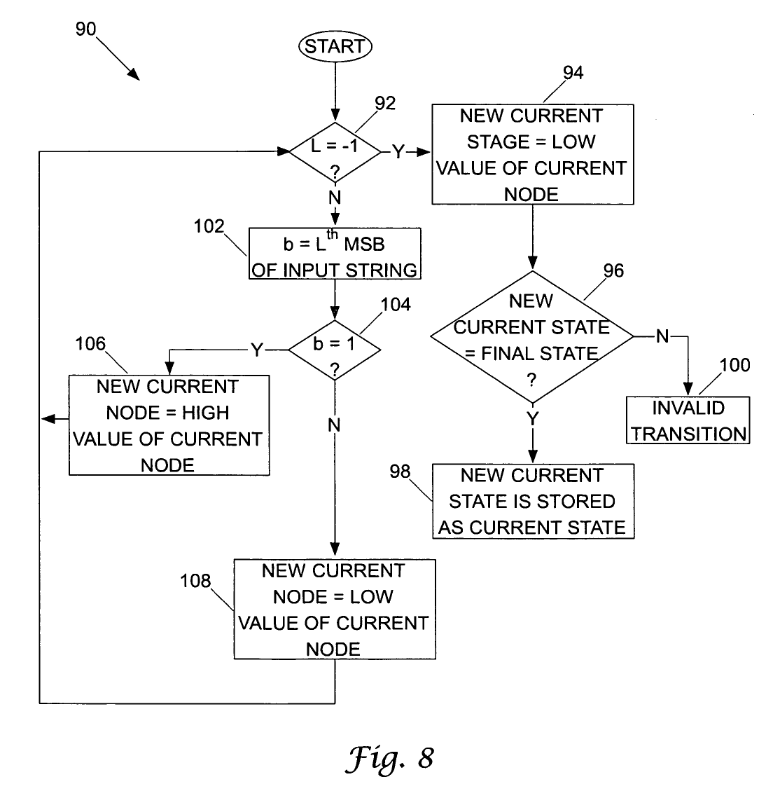

An example execution logic 90, corresponding to the execution logic that is stored on the small intelligent device 46, is shown in FIG. 8 in the form of a flow chart. As shown in FIG. 8, the execution logic 90 processes a symbol of an input string starting at a root of the binary decision diagram by setting the starting state to the current state and the current node to the node pointed to by the current state. If the level L of the current node is −1 as determined at 92, the new current state is set at 94 to the low value of the current node and the current node is a leaf node.

Then, if the new current state is the final state as determined at 96, there is a valid transition and the new current state is stored at 98 as the current state. However, if the new current state is not the final state as determined at 96, there is an invalid transition and the current state is restored at 100 to the starting state.

If the level L of the current node is not −1 as determined at 92, then b is set to the L^{th} most significant bit of the input string at 102. If b is equal to 1 as determined at 104, the new current node is determined at 106 by the high value of the current node. However, if b is not equal to 1 as determined at 104, the new current node is determined at 108 by the low value of the current node.

In a decentralized system, there may be at least two embodiments of executing the automaton given a set of inputs. In one embodiment, the automaton execution logic is pre-programmed on the small intelligent device and is provided with the input via a communication from the reader device. In this situation, the automaton is executed on the small intelligent device.

In another embodiment, the automaton execution logic is programmed on the reader. Whenever the small intelligent device is presented to the reader, the Binary Decision Diagram data structure or the relevant part thereof is downloaded from the small intelligent device to the reader. This downloaded data structure has the state information of the automaton and the required values to process the inputs and execute one step of the automaton. The execution logic on the reader uses this information, processes the inputs to compute the new state, and writes the new state back to the smart device.

The overall logic for the execution of the automaton, however, remains the same in both of the above modes. The current state of the automaton maps to a node in the Binary Decision Diagram structure. The input is traversed down the binary tree rooted at this node. As mentioned above, the first element in the record storing the node, in the column denoted “Level”, denotes which bit of the input to use for comparison. Depending upon whether that bit is zero or one, the appropriate sub-tree is followed down to the leaf node—directed by the second (Low) or third (High) element in the record, respectively.

The actual process of decision making may depend upon the policy specifications and execution logic, e.g., a default allow vs. default deny policy, or an execution roll-back vs. a reachability analysis based execution logic.

As an example from event-driven access control, a set of inputs comprises a bit encoding word of various events followed by a bit encoding word of access requests and access grants. This set of input words is processed by the small intelligent device and this process results in an actual grant of access only if the automaton ends up in one of the accepting states after the access request and access grant words are consumed. If, after consuming the input words, the automaton is not in one of the final states, then the execution of the automaton is rolled back to the point before consumption of these input words began.

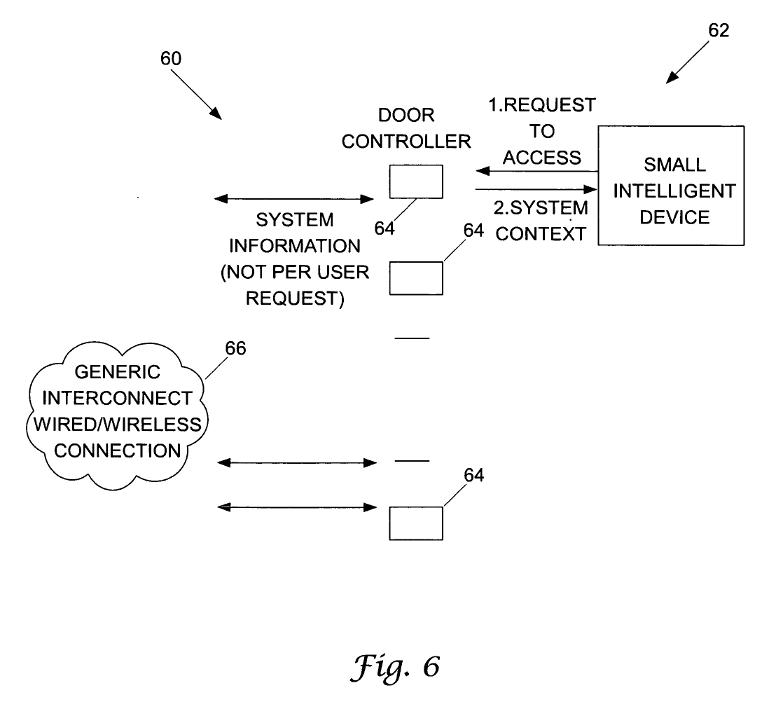

As shown in FIG. 6, decentralized access control is an example of an application scenario that makes use of the execution framework on a small intelligent deice as described above. One motivation for this uniform framework for access control is to make the system easily scalable and easy to configure in cases of very large facilities/townships and an unbounded number of users.

The traditional access control system uses passive readers which have no processing or memory capabilities. Passive readers read the data available in the access card provided by the user and relay the read information to a centralized controller/panel which contains the access control rules and policies that need to be enforced. The passive readers are hard-wired to the centralized access control panel.

The sequence of steps that is required for an access control decision in this traditional system is as follows. First, the user requests access to a location (such as a room) by presenting the required credentials stored on an access control card to a passive reader. The card has information that uniquely identifies the user to the system.

Second, the card provided by the user is read by a passive reader and the read information is relayed to a centralized controller. The centralized controller stores the access control policies pertaining to all the users of the access control system. The controller uses the information read from the card and provided by the reader to search for those policies applicable to the user in the context of the request.

Third, the access policy to be enforced for the user for the current request is extracted.

Fourth, the decision (allow or deny) is made by the centralized controller and is relayed back to the passive reader which enforces the decision by using an actuator attached to the access point, such as a door.

This series of steps imposes a huge limitation on scalability when the number of users increases significantly (i.e., the access control lists explode), or when the size of facility increases significantly (i.e., requiring enormous amounts of network traffic for “every” access decision).

On the other hand, a decentralized access control system architecture 60 such as that shown in FIG. 6 may be provided where a small intelligent device 62 contains the information required for making decisions to allow/deny a user's request. This architecture may consist of components which have loose interactions among them.

The policies/rules to be enforced on a per user basis are stored in the memory of the small intelligent device 62. Also, the small intelligent device 62 contains a processing capability for processing the data. The access points are provided with door controllers 64. The door controllers 64 are devices that are stateless, which means that they do not depend on the data/information pertaining to the past set of activities or events of the user. The door controllers 64 read the policy information available in the small intelligent device 62 to decide on the next set of actions related to the request made by the user. The door controllers 64 are connected to a ‘Generic Inter-connect’ 66 which may be wired or wireless. The inter-connect 66 is primarily used to perform updates of system wide events to the door controllers 64 so that the updates may be used during request decision process by the door controller.

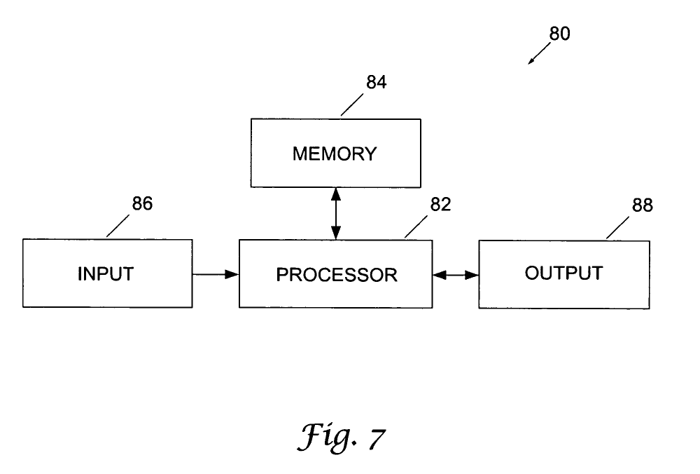

A representative example of a small intelligent device 80 is shown in FIG. 7 and includes a processor 82, a memory 84, an input 86, and an output 88. The memory 84 stores one or more Binary Decision Diagrams. Depending on the embodiment of the decentralized system, the memory 84 also stores the execution logic that processes the input and the Binary Decision Diagram to make a grant/deny decision.

The processor 82, for example, may be an application specific integrated circuit, a programmable gate array, a microprocessor, or any other device capable of executing the execution logic.

The input 86 and the output 88 form an input/output interface such as a separate receiver and transmitter or a transceiver that combines the functions of the receiver and the transmitter. The input/output interface, for example, may be a magnetic, RF, optical, sonic, or other device capable of receiving from and transmitting to the door controllers 64. Further, the input/output interface, for example, may be a wireless device.

If the memory 84 stores the execution logic that processes the input and the Binary Decision Diagram to make a grant/deny decision, the input 86 receives input words from a door controller and consumes those input words in making the grant/deny decision as discussed above, and the output 88 transmits this decision to the door controller 64.

In another embodiment of the decentralized system, the memory 84 stores only the Binary Decision Diagram, and the door controller 64 stores the execution logic. In this case, the input 86 receives an instruction from the door controller 64 to download through the output 88 the Binary Decision Diagram when the small intelligent device is presented to the door controller 64. The door controller 64 then consumes each bit of the input word in succession to traverse through the nodes of the Binary Decision Diagram and reach a node that signifies a state of the automaton. A decision is made based on this state of the automaton.

Input words are derived from 1) actions of the users, e.g., in the access control domain, a user may “request” access to a resource, “obtain” a resource, “relinquish” one, and “enter” or “exit” a room, and 2) actions or events in the system, e.g., in the access control domain, a new context like “room capacity full,” or “supervisor present,” or emergencies like “fire” or “forced-entry”.

Certain modifications of the present invention have been discussed above. Other modifications of the present invention will occur to those practicing in the art of the present invention.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A small intelligent device comprising:
a memory storing a finite state automaton;
an input/output interface that receives an input and provides an output;
a processor, wherein the processor is arranged to receive the input and to traverse the finite state automaton stored in the memory in order to supply the output to the input/output interface.

2. The small intelligent device of claim 1 wherein the finite state automaton stored by the memory comprises a Binary Decision Diagram.

3. The small intelligent device of claim 1 wherein the finite state automaton stored by the memory comprises an execution logic that drives the processor to process the input in order to supply the output to the input/output interface.

4. The small intelligent device of claim 3 wherein the finite state automaton embodies context sensitive as well as context independent rules.

5. The small intelligent device of claim 4 wherein the rules are fully captured by the finite state automaton and executed by the execution logic.

6. The small intelligent device of claim 3 wherein the finite state automaton stored by the memory further comprises a Binary Decision Diagram that is traversed by the processor in response to execution of the execution logic and in response to the input.

7. The small intelligent device of claim 1 wherein the small intelligent device comprises a smart card.

8. The small intelligent device of claim 1 wherein the small intelligent device comprises a SIM card.

9. The small intelligent device of claim 1 wherein the small intelligent device comprises a cell phone.

10. The small intelligent device of claim 1 wherein the small intelligent device comprises a Java-powered smart button.

11. The small intelligent device of claim 1 wherein the input/output interface is arranged to communicate with an input/output interface of a reader.

12. The small intelligent device of claim 11 wherein the reader comprises a memory, a two-way communication interface with the small intelligent device, and input-output interfaces.

13. The small intelligent device of claim 1 wherein the finite state automaton stored by the memory comprises a switching circuit representation.

14. The small intelligent device of claim 1 wherein the finite state automaton stored by the memory comprises a transition matrix.

15. The small intelligent device of claim 1 wherein the finite state automaton stored by the memory comprises an adjacency list.

16. The small intelligent device of claim 1 wherein the finite state automaton is configured to enable facility management such as physical access control.

17. The small intelligent device of claim 1 wherein the finite state automaton is configured to enable logical access control.

18. The small intelligent device of claim 1 wherein the finite state automaton is configured to automate an assembly line.

19. The small intelligent device of claim 1 wherein the finite state automaton is configured to enable supply chain management.

20. The small intelligent device of claim 1 wherein the finite state automaton is configured to enable asset management.

21. A method of programming a small intelligent device comprising:
populating a memory of the small intelligent device with a data structure of a finite state automaton;
initializing the finite state automaton to an initial state, wherein the finite state automaton is of a type that transitions from the initial state to a next state in response to an input and the data structure that stores the finite state automaton.

22. A system comprising:
a small intelligent device having a device memory, a device communication input/output interface including two-way communication channels, and a processor, wherein the device memory stores a data structure of a finite state automaton; and,
a reader device that has a memory, a two-way communication interface with the small intelligent device, and an input-output interface, wherein the reader memory stores an execution logic of the finite state automaton;
wherein the device communication interface and the reader communication interface are arranged to interact so as to execute the finite state automaton.

23. The system of claim 22 wherein the data structure of the finite state automaton is in the form of a Binary Decision Diagram.
